(19) United States
(12) Patent Application Publication
(10) Pub. No.: US 2009/0053425 A1
(43) Pub. Date: Feb. 26, 2009

(54) Assembly of nano-particles using DNA-mediated charge trapping

(75) Inventors: Chii-Dong Chen, Si-Tsu City (TW); Hung-Yi Lin, Tainan (TW); Li-Chu Tsai, Si-Tsu City (TW)

Correspondence Address: COHEN, PONTANI, LIEBERMAN & PAVANE LLP, 551 FIFTH AVENUE, SUITE 1210, NEW YORK, NY, 10176, US

(73) Assignee: Academia Sinica, Taipei (TW)

(21) Appl. No.: 11/894,280

(22) Filed: Aug. 21, 2007

(51) Int. Cl. B05D 3/00; B05D 1/00

(52) U.S. Cl. 427/534; 427/539

(57) ABSTRACT

A method for producing single-dimensioned gold-nano-particle patterns having a single-particle resolution in which the line-width is only limited by the particle size. Initially, a focused electron beam is used to generate a positive charge layer on an SiO₂ surface. Biotinated DNA molecules attracted by these positive charges are then used to acquire Au-nano-particles revealing the e-beam exposure patterns. The particles in the single-line patterns become separated in an orderly manner, due to the repulsive force between different Au colloidal particles. Each single-line pattern has potential use in nano-photonics and nano-electronics. In nano-electronics, the line patterns serve as a template for high or low resistance conductive nano-wires. Low resistance wires exhibit linear current-voltage characteristics with an extremely high maximum allowed current density. The high resistance wires display charging effect with clear Coulomb oscillation behavior at low temperatures. The method of the invention can produce interconnects as well as single-electron-transistors. In addition, the method permits flexibility and opens up possibilities for fabrication of integrated circuits.

### BACKGROUND OF THE INVENTION

1. Field of the Invention

The present invention generally relates to the field of nano-technology and nano-particles, and more particularly, to a method for assembling nano-particle patterns with single-particle resolution using DNA-mediated charge trapping techniques, and applications thereof.

2. Description of the Related Art

The technology associated with synthesizing nano-particles is well known. In addition, the physical properties of nano-particles have been thoroughly studied. Both of these factors has led to the nano-particle being considered one of the key building blocks for nano-devices.

Nano-particle devices that includes electronics are described in Wu et al. Applied Physics Letters, Vol. 81, pg. 4595 (2002). Other nano-particle devices that include electronics are described in Weiss et al. Applied Physics Letters, Vol. 88, pg. 143507 (2006) and Andres et al. Science, Vol. 272, pg. 1323 (1996). Nano-particle devices including photonics are described in Krenn et al. Physical Review Letters, Vol. 82, pg. 2590 (1999) and Lu et al. Advance Materials, Vol. 13, pg. 34 (2001). Such nano-particle devices have attracted a considerable level of attention. In addition, the techniques for arranging nano-particles in specific predetermined locations are beginning to play an important role with respect to the integration of nano-devices and circuits.

Conventional techniques that are utilized to achieve such an integration fall into two main categories, i.e., the atomic force microscope (AFM) tip manipulation of nano-particles and the self-assembly method, which invokes inter-particle or particle/substrate interactions. Self-assembly is of particular interest because of its superior functionality and prevailing fabrication speed. Various interaction mechanisms have been utilized for particle assembly or binding. However, electrostatic interaction of the particles is one of the preferred methods for particle assembly. The electrostatic interaction of this preferred method can be exerted between vast varieties of materials, and is much more general and reliable than other specific binding methods.

Several research groups have recently used electrostatic interaction mechanisms to assemble particles, and to thereby adduce evidence to support this seemingly promising approach. The use of an electron beam to generate trapped charges, which can then induce a dielectrophoretic force for particle assembly, is discussed in Fudouzi et al. Nanopart. Res., Vol. 3, pg. 193 (2001). The development of a nano-xerography technique in which nano-particles were assembled onto the charge patterns produced by injecting charge through nano-contacts is described in Jacobs et al. Advanced Materials, Vol. 14, pg. 1553 (2002). An electrostatic force microscopy that is used to create high-resolution electrostatic patterns, which can then attract particles in solution, is discussed in Tzeng et al. Advanced Materials, Vol. 18, pg. 1147 (2006). The particle line resolutions achieved in each of these conventional methods ranges between 30 and 100 nm, and are limited by multiple particles that are present in the cross-section of the particle line. However, no line patterns with a single particle resolution were achieved using any of these known methods.

It is known to combine the electrostatic trapping method with a selective molecular binding method so as to permit the formation of sophisticated nano-particle superstructures. One example of such a use is during the fabrication of molecular electronics, which holds great promise in complimenting present-day semiconductor devices due to its advantages with respect to high packing density, low power consumption, as well as low manufacturing costs. Numerous examples of molecular electronics made by selective binding exist. A thiol-gold colloidal particles composite, which is one of the most commonly used systems, is described in Mirkin et al. Nature, Vol. 382, 607-609 (1996). Other conventional methods for selective binding have been directed towards utilizing DNA as a template for assembling materials. See Braun et al. Nature, Vol. 391, pg. 775 (1998); Keren et al. Science Vol. 302, pg. 1380 (2003); Nakao, et al. Nano Letters. Vol. 3, pg. 1391 (2003); Lin et al. Advanced Materials, Vol. 18, pg. 1517 (2004); and Warner et al. Nature Materials, Vol. 2, pg. 272 (2003). Self-assembly with DNA molecules possesses unrivaled advantages because of the accurate level of synthesis and highly specific hybridization characteristics associated with DNA. (See Seeman, Nature, Vol. 421, pg. 427 (2003)). However, it is still not possible to achieve a resolution to a single particle at a desired position using most of the foregoing methods.

### SUMMARY OF THE INVENTION

The invention relates to a method for assembling nano-particle patterns with single-particle resolution using DNA-mediated charge trapping techniques, and applications thereof. In accordance with the invention, gold nano-particle chains are produced by Coulomb attraction of biotinated DNA molecules and attachment of nano-particles. In accordance with the method of the invention, the underlying charge patterns are generated by a focused and accurately positioned electron beam source at controlled dosage levels. Here, the chains serve as interconnecting wires or single-electron transistors.

In accordance with the inventive method, charge trapping of biotinated DNA molecules and thiol-Au colloidal binding are used to produce nano-particle patterns at pre-designed locations to a resolution of a single-particle. In the preferred embodiment, the diameter of the Au particles used is about 13 nm. Utilizing electron beam writing, charge patterns are created on Si substrates to immobilize small clustered oligonucleotides, which in turn are attached to individual Au particles and, thus, form single-line patterns.

The present inventors have determined that the introduction of oligonucleotides during the inventive method is a key factor in obtaining the advantageous results of the present invention. Without the oligonucleotides, it is not possible to achieve the desired resolution using known, conventional electrostatic trapping methods.

The contemplated method of the invention permits the production of one-dimensional arrays of inter-particle linear tunnel junctions with high or low transparencies, which can function as interconnecting wires and single electron devices, respectively. In addition, the method permits the construction of functional devices, such as nano-scale waveguiding arrays, sensors and optoelectronics at specific desired locations.

The method of the invention thus provides a way to make individual nano-devices and construct nano-scale assemblies using a minimum number of lithographic steps. That is a way of provided to construct single line particle chains at designated nano-metric locations. Small amounts of a positive charge are implanted within a nano-metric region and used to attract small clusters of biotinated DNA molecules using an appropriate application level of the electron beam. These biotinated DNA molecules are consequently bound with Au particles to form desired patterns. For applications in electronics, the contemplated method of the invention bridges the Au particles to create conductive nano-wires. The development of interconnecting wires and single electron transistors for use in nano-electronics and integrated devices are exemplary applications of the method of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIGS. 1(a) thru 1(g) are illustrations of scanning electron microscope (SEM) images of fabricated Au-nano-particle single-line patterns;

FIG. 2 is a diagram illustrating the procedures of a complete bridging cycle for making conductive nano-wires;

FIGS. 3(a) thru 3(g) are illustrations of SEM images of fabricated one dimensioned Au particle arrays and nano-wires;

FIG. 4 is an illustration of a histogram of sample numbers as a function of their room temperature resistances per 100 nm;

FIGS. 5(a) thru 5(c) is a graphical illustration of the I-V_{b} characteristics of a connected nano-particle wire; and

FIG. 6 is an exemplary illustration of a surface plasmon resonant image of a 42 nm gold nano-particle wire illuminated in accordance with the method of the invention.

### DETAILED DESCRIPTION OF THE EXEMPLARY EMBODIMENTS

The invention relates to a method for assembling nano-particle patterns with single-particle resolution using DNA-mediated charge trapping techniques, and applications thereof. In accordance with the invention, gold nano-particle chains are produced by Coulomb attraction of biotinated DNA molecules and attachment of nano-particles. In accordance with the method of the invention, the underlying charge patterns are generated by a focused and accurately positioned electron beam at controlled dosage levels. Here, the chains serve as interconnecting wires or single-electron transistors.

In accordance with the inventive method, charge trapping of biotinated DNA molecules and thiol-Au colloidal binding are used to produce nano-particle patterns at pre-designed locations to a resolution of a single-particle. In the preferred embodiment, the diameter of the Au particles used is about 13 nm. Utilizing electron beam writing, charge patterns are created on Si substrates to immobilize small clustered oligonucleotides, which in turn are attached to individual Au particles and, thus, form single-line patterns.

The present inventors have determined that the introduction of oligonucleotides during the inventive method is a key factor in obtaining the advantageous results of the present invention. Without the oligonucleotides, it is not possible to achieve the desired resolution using known, conventional electrostatic trapping methods.

The contemplated method of the invention permits the production of one-dimensional arrays of inter-particle linear tunnel junctions with high or low transparencies, which can function as interconnecting wires and single electron devices, respectively. In addition, the method permits the construction of functional devices, such as nano-scale waveguiding arrays, sensors and optoelectronics at specific desired locations. The method of the invention thus provides a way to make individual nano-devices and construct nano-scale assemblies using a minimum number of lithographic steps.

A focused electron beam generated by an electron gun source and directed by a computer controlled digital-to-analog converter (DAC) is commonly used to generate very fine patterns on electron beam resists for further lithographic processes. This electron beam lithographic technique is one of the few mask-less lithographic systems available in the semiconductor fabrication industry. In contrast to exposure on resists, the method of the invention utilizes a focused, directional electron beam to generate trapped charges on dummy SiO₂-coated silicon wafers. When an insulating substrate is irradiated by an electron beam, electron-hole pairs are created as the charge carriers. Here, a portion of the charge carriers are recombined or trapped by impurities, defects or cracks, while others, at this time, may escape from the surface of the substrate. The resultant electrostatic imbalance that is created is such that the insulator is either negatively or positively charged.

It is well known that DNA molecules carry slightly negative charges in common buffer solutions. As described in Renoud et al. Phys. Status Solidi. a 2004, 201, 2119, an insulator irradiated by an electron beam often becomes negatively charged. As a result, use of an insulator irradiated in such a manner pursuant to immobilizing DNA molecules is not performed. However, as described in Cazaux, J. Appl. Phys. Vol. 95, pg. 731 (2004), upon electron beam irradiation on an insulating surface, a layer of highly localized positive charges with a thickness about the electron mean escape depth (5-20 nm) is created at the irradiated location, although the net charge in the region of irradiation is negative. As described in Chi et al. Nanotechnology, Vol. 17, pg. 4854 (2006), the localized charges are quite stable and do not decay with the passage of time, as long as high temperatures and a high electric field are not present.

Chi et al. further describes that in an ionic solution, the negatively charged particles close to the irradiated area may overcome the shielding potential and attach to the insulating surface. However, it is known that the charged lines in such a situation will generally be broadened due to random scattering of secondary electrons that occurs. As a result, multiple particle line width is generated. Small levels of exposure to the electron beam help to narrow the charged line at the expense of reducing the force of attraction to a level that is below the threshold value for holding Au particles together.

Here, small amounts of biotinated DNA molecules were attracted by charges generated by a finely focused low level application of electron beam. Au particles were then attached to the thiol in the biotin. In accordance with the method of the invention, the problem associated with the attraction force between the Au particles and the substrate is solved by the use of oligonucleotides, because of their small size and light weight in comparison to the Au particles.

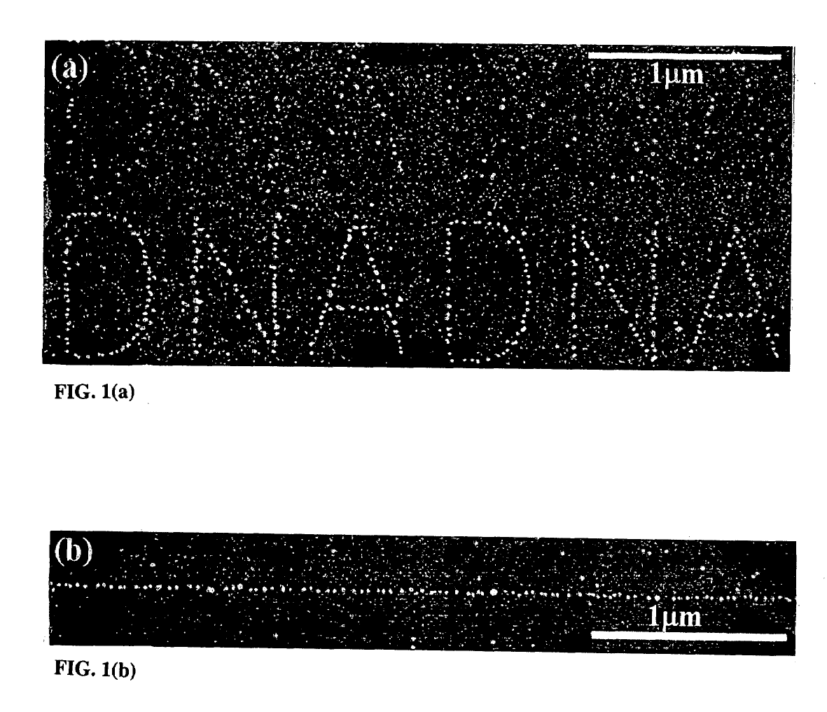

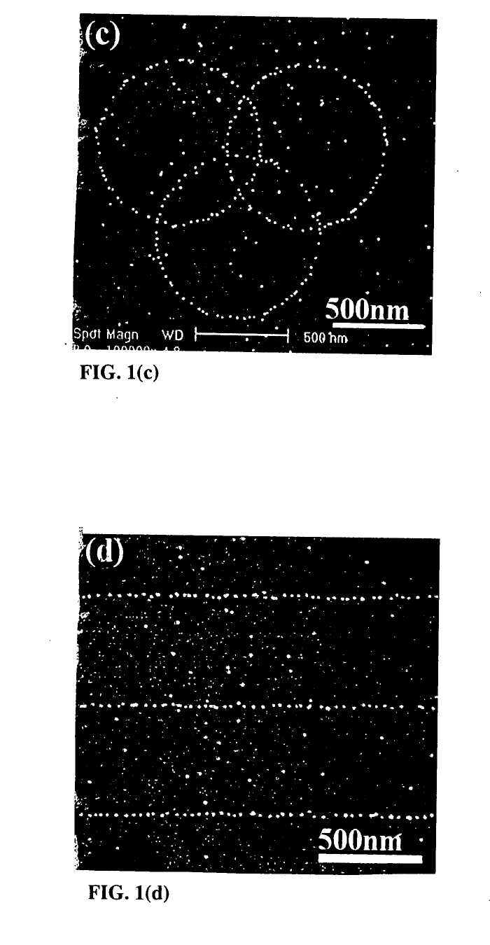

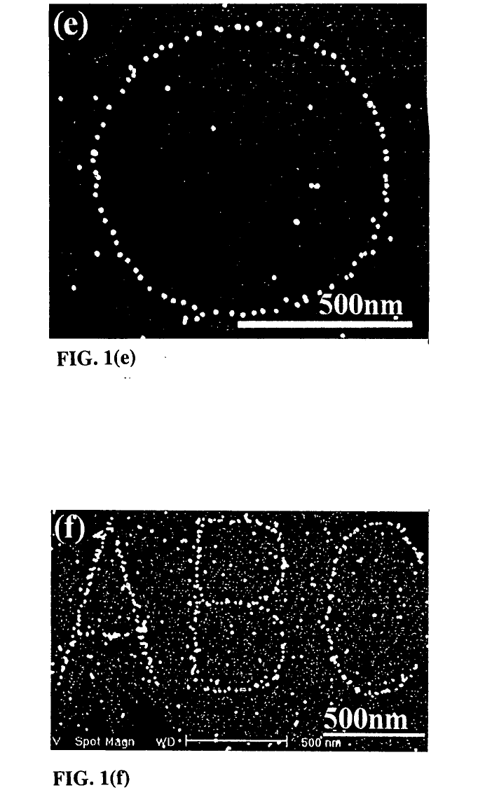

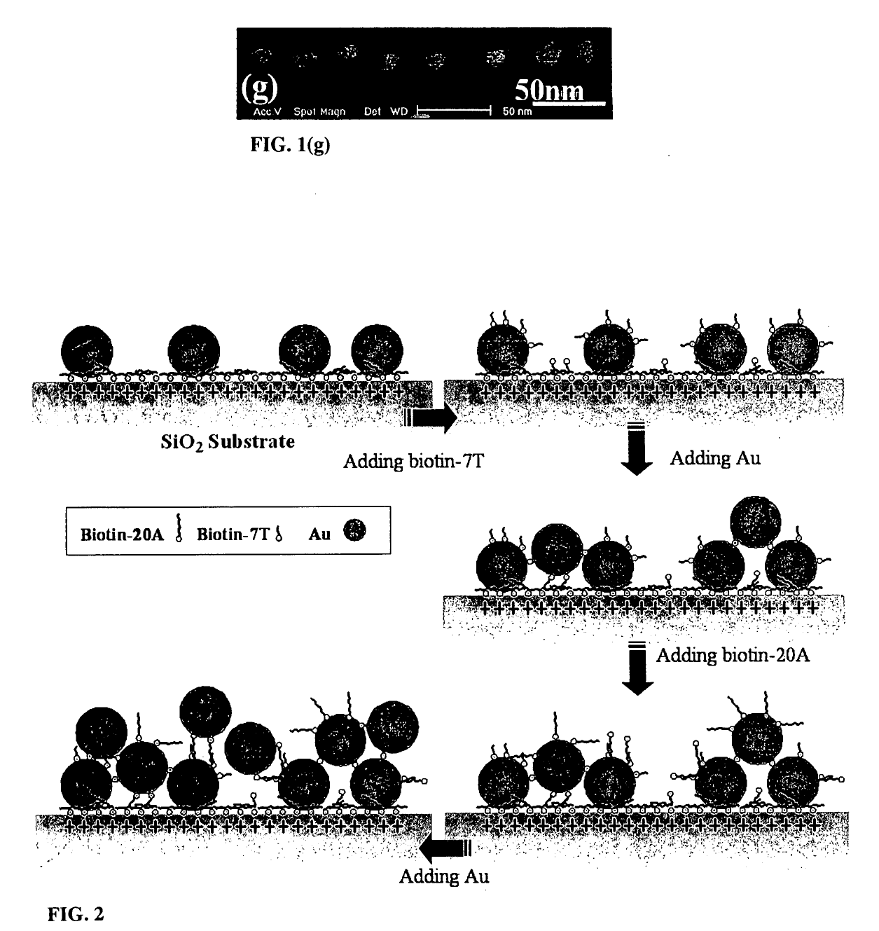

FIGS. 1(a) thru FIG. 1(g) are illustrations of scanning electron microscope (SEM) images of fabricated Au-nano-particle single-line patterns. Here, the length of the illustrated straight, single-line, particle chains in FIGS. 1(b), 1(d) and 1(g) varied from tens of nano-meters to tens of micrometers. In particular FIG. 1(a) shows four sets of Au-particle patterned “DNA” characters generated by different exposure levels of the electron beam. These patterns suggest that the appropriate exposure of the line to the electron beam is between 2.5 and 4.0 nC/cm. In this case, further increases of the exposure level causes more particles to be attracted together, thereby blurring the single-line feature and consequently creating a line width that is larger than the particle size.

FIG. 1(g) shows a magnified image of a single-line Au-particle chain with an average separation between two adjacent particles that is roughly equal to the particle size. Here, testing with an electron beam at various pulse intervals resulted in no corresponding change in particle separation. As a result, the separation of the particles is mainly due to a weak repulsive force between Au particles, rather than the discreteness of the charge distribution, and the present inventors have determined that such a conclusion is reasonable.

From top-right to bottom-left, the four writings of “DNA” in FIG. 1(a) were generated utilizing a level of electron beam line exposure from 1.0, 1.5, 2.5, and 4.0 nC/cm, respectively. In FIGS. 1(b) thru 1(G), the patterns were created using a line exposure level of 2.5 nC/cm. For all patterns, however, the center-to-center distance between the electron beam pulses was set to a fixed, specific value. In the preferred embodiment, the specific value is 13.6 nm.

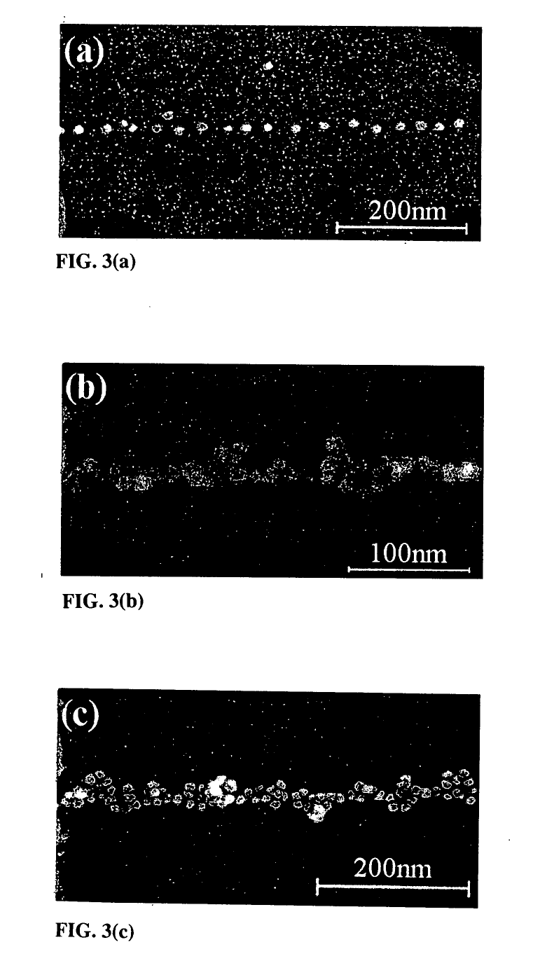

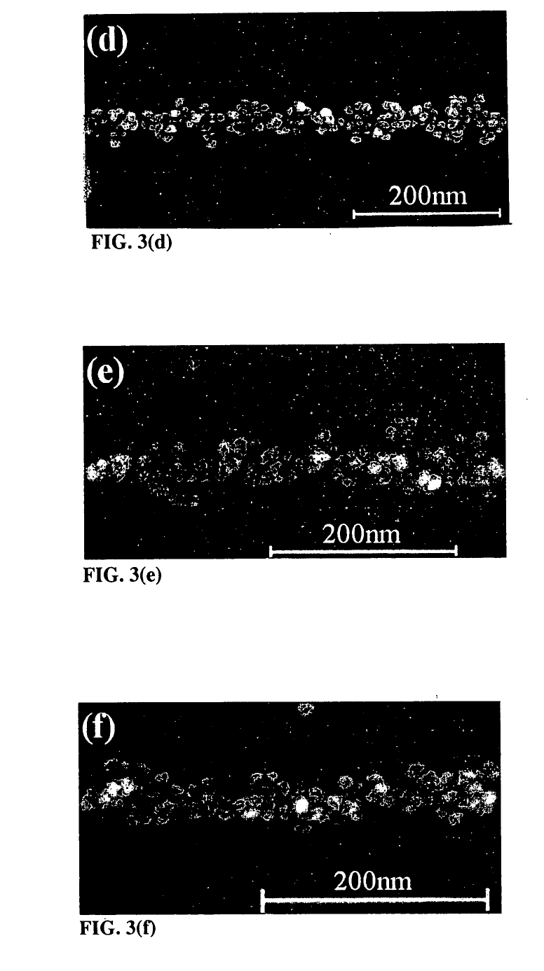

In order to create electrical components, it is required that Au particles are closely linked to permit electrical conduction, as illustrated in FIG. 3(g). FIG. 2. is a schematic diagram illustrating the procedures of a complete bridging cycle for making such conductive nano-wires. As shown in FIG. 2, repeated application of the bridging cycle illustrated in FIG. 2 forms colloidal Au nano-wires with inter-particle tunnel junctions (also see FIGS. 3(b) thru 3(g)).

FIGS. 3(a) thru 3(g) are illustrations of SEM images of fabricated single dimensioned Au particle arrays and nano-wires, where FIG. 3(a) shown the line structure prior to implementation of the bridging cycle, FIGS. 3(b) and 3(c) shown the line structure after one bridging cycle and FIGS. 3(d) thru 3(f) show the line structure after two bridging cycles. FIG. 3(g) is an illustration of an Au particle nano-wire attached between a pair of electrodes to permit the performance of electrical measurements. The present inventors have also determined that the more cycles applied, the lower the wire resistance will become, where the wires possess linear current-voltage (I-V_{b}) characteristics at room temperature, and the resistance values will be divided substantially into two groups.

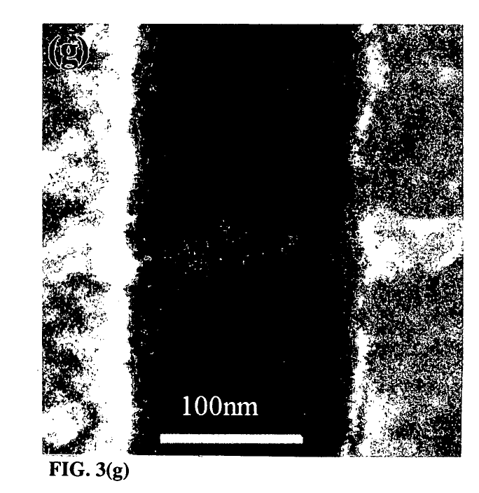

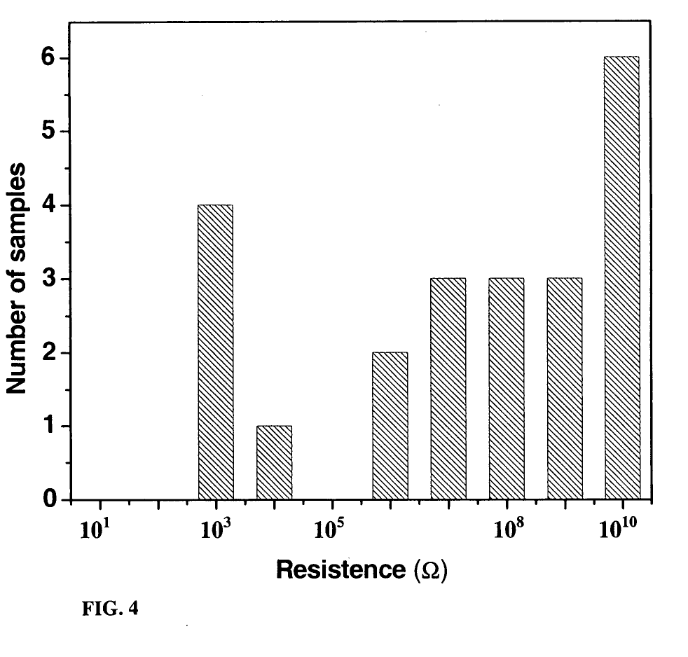

FIG. 4 is an illustration of a histogram of sample numbers as a function of their room temperature resistances per 100 nm. That is, FIG. 4 is an illustration of a histogram of the measured resistance for wires assembled using two bridging cycles. With reference to FIG. 4, it is clearly shown that the wires have either a low level of resistance (high transparence) or a very high level of resistance (low transparence). This bifurcation behavior is attributable to two types of bridging mechanisms, i.e. (i) if particles were bound by the biotins alone, the separation is small and the wire resistance is low and (ii) if the particles were bound by hybridization of 20-base poly-A nucleotides (5′-(A)₂₀-3′) or (20A), and 7-base poly-T nucleotides (5′-(T)₇-3′) or (7T), then particle separation becomes larger and the wire resistance is high and more widely spread (as shown by the high resistance side of FIG. 4, i.e., at 10¹⁰ on the graph).

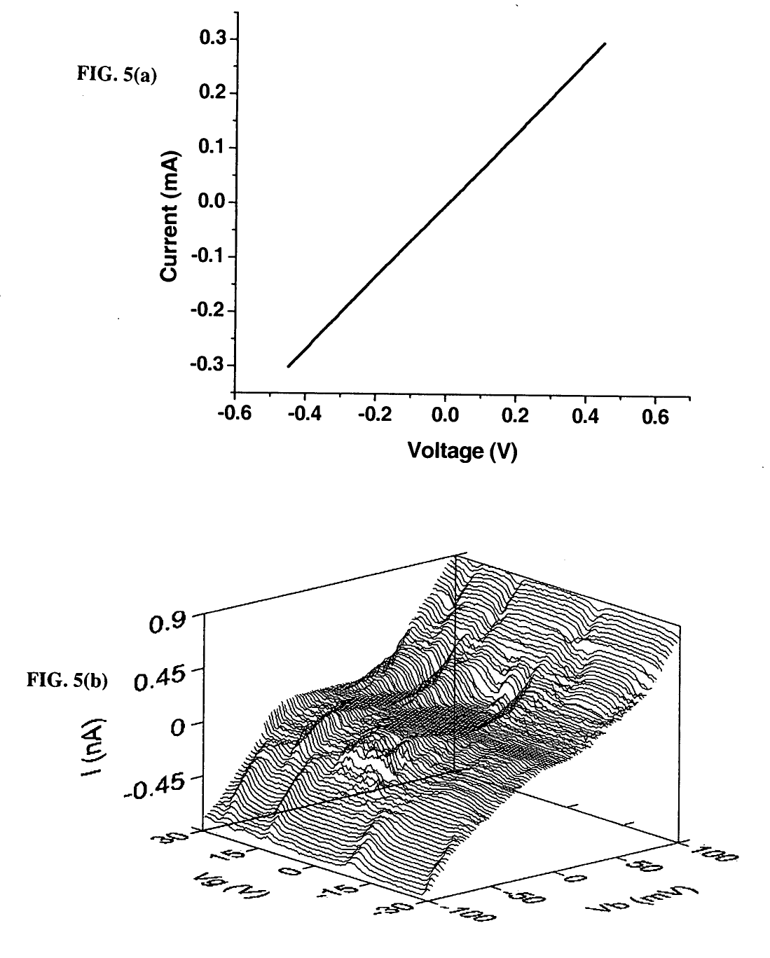

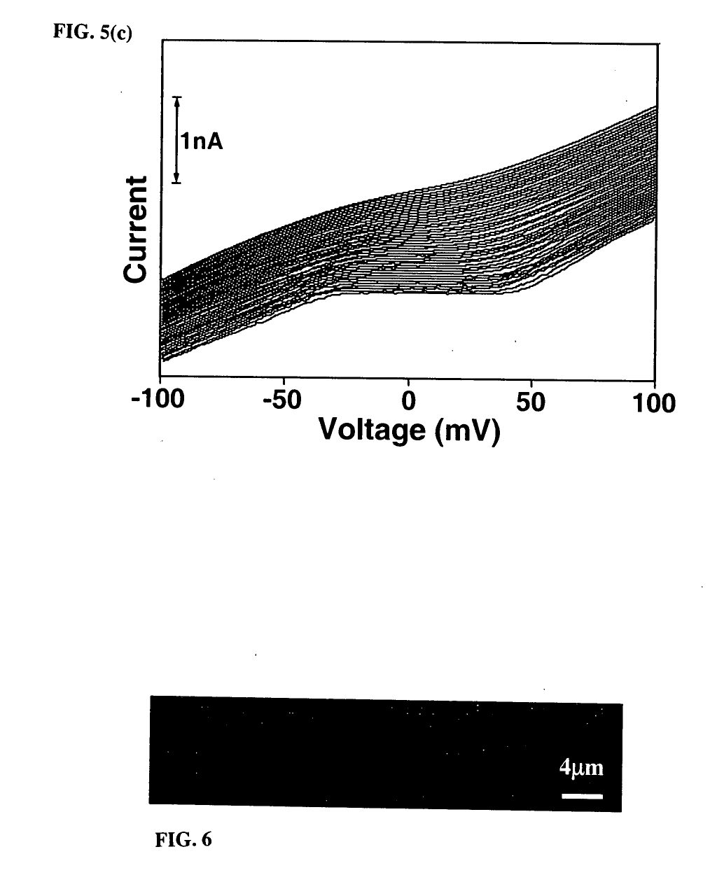

FIG. 5(a) is a graphical plot of the I-V_{b} characteristic of a connected nano-particle wire with resistance of 1.5K ohms. With reference to FIG. 5(a) all low resistance wires exhibited a very stable linear I-V_{b} dependence, where the linear region extends up to a current of approximately 0.3 mA and the resistance is 1.5K ohms. In the case of an effective wire diameter of 10 nm, this would correspond to a current density of 2.6×10⁸ A/cm², which is about 2 orders of magnitude greater than that of multilevel cooper interconnects used in deep nano-meter scale CMOS technologies, as described in Im et al. IEEE Trans. on electron devices, Vol. 52, pg. 2710 (2005). In accordance with the method of the invention, approximately 10 hopping sites in series between the two electrodes are utilized and a junction resistance of 150 ohms is inferred in order to estimate the junction resistance between a pair of electrodes.

In reality, however, the actual junction resistance is preferably smaller than the estimated junction resistance value, because lead resistance (measured to be approximately 150 ohms), lead-particle contact resistance and the internal resistance of the Au particles are not taken into account during the estimation. Linear current-voltage characteristics, together with a high current density, permit the wires made using the method of the invention to perform as well as interconnecting cooper wires.

FIG. 5(b) is a graphical plot of gate-voltage modulations of source-drain currents at various bias voltages for a wire having a resistance of approximately 33 M ohms at room temperature. The graphical plots shown in FIG. 5(b) were obtained at a temperature of 6K. The zero-current Coulomb parallelogram and Coulomb oscillations are signatures of single electron transport. The present inventors have determined that similarly to the low-resistance wires, the I-V_{b} characteristics for the high resistance wires at room temperature are linear, but exhibit a suppression of current in the low bias region at low temperatures. The suppression current exhibited a clear oscillatory modulation with the applied gate voltage (Vg). The behavior is best represented by the clear zero-current parallelogram seen in the 3-D plot of FIG. 5(b). The zero-current parallelogram is attributed to the presence of a charging effect that arises from a small capacitance with respect to the Au-particles, which manifests itself in Coulomb blockade in the I-V_{b} characteristics and Coulomb oscillation in the I-V_{g} characteristics. As the temperature is lowered from 300K to 5K, the resistances of most of the wires increases by about 5˜20%, regardless of whether the wires have a high or a low level of resistance.

FIG. 5(c) is a graphical plot of the I-V_{b} characteristics of the same interconnected wires, but measured at substrate temperatures between 5K (the lower region of the curve) and 85K (the upper region of the curve). It should be noted that within the illustrated graphical plot of FIG. 5(c), the curves are shifted vertically so as to provide a greater level of clarity. With specific reference to FIG. 5(c), shown therein is an example of the I-V_{b} characteristics of a high-resistance wire measured while substrate temperatures are lowered from 87K to 7K. Although in the low-bias region, the resistance of the wire increases with decreasing the substrate temperature by more than 3-orders of magnitude due to Coulomb blockade effect, the resistance of the wire at the high bias voltage region, which is the resistance of the segments connecting the dominating charging particle, increases by about 15%. This increase in the wire resistance indicates that conduction electrons “hop” between nano-particles, and that the separation between particles increases slightly with decreasing substrate temperatures.

As for the stability of the bound particles, the particle structures will remain intact, even as the substrate temperature is varied between 6K and 523K (250° C.). By careful SEM inspection of samples stored for an extended time period, such as up to 6 months, the present inventors have determined that even heavy washing with water or acetone does not move or remove any gold particles from the samples. Consequently, it is apparent that a strong adhesion between the Au particles and the substrate, as well as a high level of inter particle binding is advantageously achieved.

Outside of the field of electronics, such nano-particle chain structures also have the potential for applications in nano-photonics with selective frequency response by surface plasmon resonance, and can also be used to construct nano-scale waveguides, switches, sensors and the like. In physics, the plasmon is the quasiparticle that results from the quantization of plasma oscillations, similarly to the photons and phonons which are quantizations of light and sound waves. Consequently, plasmons are collective oscillations of the free electron gas density, often at optical frequencies. It is also possible for plasmons to couple with a photon to create a third quasiparticle called a plasma polariton.

The excitation of surface plasmons by light is called a surface plasmon resonance (SPR) for planar surfaces or localized surface plasmon resonance (LSPR) for nano-meter-sized metallic structures. This phenomenon is the basis of many standard tools for measuring adsorption of material onto planar metal surfaces (e.g., gold and silver) or onto the surface of metal nano-particles. The phenomenon is behind many color based biosensor applications and different lab-on-a-chip sensors.

It is known that gold nano-particles possess large scattering cross-sections at optical wavelengths due to the resonant excitations of collective oscillations of conduction electrons within particles. As a result, a single particle dimensioned gold nano-particle chain or wire has great potential for guiding electromagnetic energy due to local-field enhancement and strong scattering. The ability of a single particle dimensioned gold nano-particle chain or wire to convert optical mode into non-radiating surface plasmons, and to guide light below a diffraction limit is unique and cannot be achieved using conventional waveguides or photonic crystals. However, the inventive method of the invention advantageously provides a way to fabricate such a gold particle chain or wire with precise, spatial control of the design. As a result, the realization of functional optical devices is made possible.

A surface plasmon resonant image of a 42 nm gold nano-particle wire is illustrated in FIG. 6, which was obtained using a camera from an inverted microscope. Here, the CCD camera is for example, a color CCD camera (Nikon 70D) and the microscope is, for example, an Olympus IX71 with a 40× objective lens. In this case, the nano-particle sample was illuminated with a tungsten light source at approximately 43° along the axis of the wire. Such an approximately 50 nm wide gold nano-wire is easily observed using an optical microscope, due to the collective resonance of the conduction electrons in the wire. Such observations show light scattered elastically with remarkable efficiency. An SEM image of the same wire is shown in FIG. 3(d).

An exemplary method of the invention utilizes two types of biotin-modified oligonucleotides, such as 5 μM 5′-biotin-(A)₂₀-3′ and 5 μM 5′-biotin-(T)₇-3′ (MDBio, Inc., Taiwan) (i.e., biotin-20A and biotin-7T). Each of the biotin-modified oligonucleotides is suspended in a 1.0 M KH₂PO₄ solution having a specific pH. In the preferred embodiment, the pH is 4.3. Here, as described in Herne et al. Chem. Soc., Vol. 119, pg. 8916 (1997), the buffer concentration has an important role in the thiol-Au interaction. In order to link biotin to DNA molecules, the biotin is then attached with a (CH₂)₆-segment that provides bonding to the 5′-end of the DNA molecules. As a result, a biotin-DNA structure or biotinated-DNA is achieved. It is relevant to note that biotin contains a thiol group that allows strong binding to Au-nano-particles.

The colloidal Au used in accordance with the exemplary implementation of the inventive method is prepared by citrate reduction of HAuC₄□3H₂O, in accordance with the procedure described in Grabaret al. Anal. Chem., Vol. 67, pg. 735 (1995). A substrate comprising silicon chips 7×7 mm covered with 400 nm thick, thermally oxidized SiO₂ layer are also used.

In accordance with the method of the invention, the substrate is initially cleaned in acetone before being blow-dried with nitrogen. This step is then followed by oxygen-plasma treatment in a reactive ion etcher for a predetermined time period. In the preferred embodiment, the predetermined time period is 1 minute. The plasma treatment serves a dual purpose. Firstly, it serves to remove residual organic compounds. Secondly, it serves to create a slightly negatively charged surface to prevent non-specific binding of DNA molecules.

Next, a focused electron beam from a modified field-emission scanning electron microscope, such as a FEI Sirion 200, is directed onto the specific areas by a computer controlled DAC, such as a DAC provided by NPGS, so as to generate a pattern of embedded charges. Here, caution must be exhibited to avoid any unwanted electron exposure during alignment procedures, because a trace amount of exposure may cause undesired embedded charges and consequent particle attachment.

A small sample of biotin-20A solution is then placed onto the substrate sample and maintained there for an extended time period to permit electrostatic attraction of the DNA molecules. Subsequently, the sample substrate is washed with de-ionized water and blow dried before adding the prepared gold particle solution to the biotin-20A solution on the substrate. In the preferred embodiment, the extended time period is 15 minutes.

After waiting for another predetermined time period to permit binding between the Au particles and sulfur atoms in the biotins, the sample substrate is rewashed with de-ionized water and blow dried for further SEM inspections. In the preferred embodiment, the predetermined time period is 30 minutes.

In accordance with a contemplated embodiment of the invention, a bridging cycle method for closely connecting Au particles in the chains is implemented, such as in the manner illustrated in FIG. 2. Here, a biotin-7T solution is initially added to the existing Au-particle chains to bind the Au particles with the biotin. Au particles are then re-added to bind with the biotin on the surface of the substrate, or to bind with the biotin on the Au particles.

Next, biotin-20A solution is added to the single-strand biotin-7T. Here, the biotin-20A either hybridizes with the single-strand biotin-7T on the Au particles or directly binds to immobilized Au particles. Finally, an additional Au particle solution is added to fill inter-particle gaps. It should be noted that after each step, the sample substrate is subjected to washing and drying procedures. In this manner, a bridging cycle for inserting Au particles into existing Au-chains is achieved.

The method of the invention provides a way to construct single line particle chains at designated nano-metric locations. With an appropriate application level of the electron beam, small amounts of a positive charge are implanted within a nano-metric region and used to attract small clusters of biotinated DNA molecules. These biotinated DNA molecules are consequently bound with Au particles to form desired patterns. For applications in electronics, the contemplated method of the invention bridges the Au particles to create conductive nano-wires. The development of interconnecting wires and single electron transistors for use in nano-electronics and integrated devices are exemplary applications of the method of the invention. Moreover, it should be readily appreciated that the contemplated embodiments of the inventive method are applicable to other particles that can be modified with biotin, such as iron-oxide, Carbon-60 (C60) or carbon nano-particles. In addition, the contemplated embodiments of the method are not limited to only the above discussed substrates, but are equally applicable to other substrates, including all insulating substrates or conductive substrates that are coated with an insulating layer. Lastly, the contemplated embodiments of the method of invention are equally application to more than the above discussed DNA molecules, for example, they may be applied to other molecules, such as polypeptides or DNA fragments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for assembling nano-particle patterns with single-particle resolution using DNA-mediated charge trapping, comprising:
cleaning a substrate in acetone before blow-drying the substrate with nitrogen;
performing an oxygen-plasma treatment of the substrate in a reactive ion etcher for a first predetermined time period;
directing a focused electron beam from a field-emission scanning electron microscope onto specific areas of the substrate to generate a pattern of embedded charges;
placing and maintaining a sample of biotin solution on the substrate for an extended time period to permit electrostatic attraction of DNA molecules;
washing the substrate with de-ionized water and blow drying the substrate before adding a prepared particle solution to the biotin solution on the substrate; and
rewashing the substrate with de-ionized water and blowing drying the substrate for further scanning electron microscope inspections after waiting for a second predetermined time period to permit binding between particles and atoms in the biotins into at least one particle chain or line.

2. The method of claim 1, further comprising:
implementing a bridging cycle to closely connect particles in the at least one chain or line.

3. The method of claim 2, wherein said bridging cycle comprises:
adding a different biotin solution to an existing particle chain to bind the particles with the biotins before adding the sample of biotin solution to the substrate;
re-adding the particles to one of bind with the biotin on the surface of the substrate and bind with the biotin on the particles; and
adding an additional particle solution to fill inter-particle gaps.

4. The method of claim 1, wherein the oxygen-plasma treatment removes residual organic compounds from the substrate.

5. The method of claim 1, wherein the oxygen-plasma treatment creates a negatively charged surface to prevent non-specific binding of the DNA molecules.

6. The method of claim 1, wherein the focused electron beam is generated by a modified field-emission scanning electron microscope.

7. The method of claim 1, wherein the focused electron beam is directed onto the specific areas of the substrate by a computer controlled DAC.

8. The method of claim 1, wherein the sample of biotin solution comprises biotin-20A.

9. The method of claim 1, wherein the extended time period is 15 minutes.

10. The method of claim 1, wherein the first predetermined time period is 1 minute.

11. The method of claim 1, wherein the second predetermined time period is 30 minutes.

12. The method of claim 1, wherein the prepared particle solution comprises a gold solution.

13. The method of claim 1, wherein the binding in the single line particle chain occurs between Au particles and sulfur atoms in the biotins.

14. The method of claim 3, wherein the sample of biotin solution comprises biotin-20A.

15. The method of claim 3, wherein the different biotin solution comprises biotin-7T.

16. The method of claim 3, wherein the biotin-7T solution is a single strand biotin.

17. The method of claim 3, wherein the sample of biotin solution one of hybridizes with the different biotin solution on the particles and directly binds to immobilized particles.

18. The method of claim 17, wherein the biotin-7T solution is a single strand biotin.

19. The method of claim 3, wherein the particles comprise Au particles.

20. The method of claim 17, wherein the particles comprise Au particles.

21. The method of claim 3, wherein the substrate is washed and dried after each of said adding, re-adding and adding steps.
